(19) United States
(12) Patent Application Publication
(10) Pub. No.: US 2026/0244484 A1
(43) Pub. Date: Aug. 20, 2026

(54) FLEXIBLE COMPUTING RACK FOR INTERRUPTIBLE ARTIFICIAL INTELLIGENCE COMPUTING IN DATA CENTERS

(71) Applicant: HammerheadAI, Inc., Redwood City, CA (US)

(72) Inventors: Rahul Kar, Redwood City, CA (US); Rajeev Singh, Redwood City, CA (US); Amit Narayan, Redwood City, CA (US)

(73) Assignee: HammerheadAI, Inc., Redwood City, CA (US)

(21) Appl. No.: 19/546,187

(22) Filed: Feb. 20, 2026

Related U.S. Application Data
(60) Provisional application No. 63/761,033, filed on Feb. 20, 2025.

(51) Int. Cl. G06F 9/48

(52) U.S. Cl. CPC G06F 9/4831

(57) ABSTRACT

Systems and methods for allocating and managing computing resources are described. The system may use a flexible computing rack which includes a plurality of server devices, an artificial intelligence engine, and power distribution units to manage and allocate data computation in a data center. The system may execute computational allocation based on interruption factors which include prioritization of tasks, electrical power consumption, device temperatures, and provide for state preservation and seamless resumption of interrupted workloads. The artificial intelligence engine may collect data representative of these characteristics of the data center, train machine learning models on rack-specific operational patterns, and provide efficiency enhancements and optimization for data computation through autonomous workload orchestration that responds to both internal rack conditions and external grid signals.

### PRIORITY CLAIM

This application claims the benefit of and priority to U.S. Provisional Patent Application No. 63/761,033 filed on Feb. 20, 2025.

### TECHNICAL FIELD

Data centers are used to compute vast amounts of data. This disclosure sets forth systems and methods which not only increase efficiency in computing this data, but which also lowers costs and provides for a dynamic and flexible computing environment.

The disclosure relates to flexible computing racks and servers within data centers and similar computing infrastructures, specifically designed to facilitate interruptible artificial intelligence (AI) computing and optimize underutilized computing power through multi-factor interruption management integrated with dual-grid power distribution and embedded rack-level artificial intelligence orchestration.

### BACKGROUND

Data centers are a relatively recent innovation, which were born out of a need to process large amounts of data. For example, statistical analyses may require processing of a significant amount of data to generate a confidence interval. Monte Carlo simulations, which are used to predict a probability of a variety of outcomes in a system, require significant processing power to test each variable in each outcome path.

Other fields require powerful computer computing techniques. For example, any field in which trends or patterns may provide some insight into what the data truly represents may rely on computing large amounts of data. Space exploration, chemistry, physics, and engineering, to name a few, use server computers to analyze data to learn more about natural processes underlying their field of study.

More recently, large data centers store and provide processing power for data generated by and for businesses. Customer relationship management information, enterprise resource planning information, social media trend information, social media platform information, e-commerce website information, search engine information, healthcare management information, education information, and voting information are examples of fields which generate significant amounts of data for which significant computing power is useful for analysis of the data.

In many situations, data centers require a significant amount of time to process a large amount of data. Conventionally, data is provided to server devices or cloud computing devices, in a management scheme that is determined by one of the server devices or cloud computing devices in a data center using a technique called parallel processing. Parallel processing increases the speed of data processing by using many server devices or cloud computing devices. Each device processes data in parallel, formulate a result based on the processed data, and provide that result back to the management server device for analysis of each portion of the result formulated by each device.

As data centers are made from a plurality of individual devices, data centers have a need for significant amounts of electricity to power those devices. Processing power is directly related to energy consumption for a data center at large. While each device in the plurality of individual devices requires a baseline amount of electricity to operate, the formal data processing requires substantially more power than the baseline. Electricity costs, therefore, have a direct effect on a financial cost of processing data.

Further, conventional data centers are generally dedicated to a particular processing task until that task is complete. In some cases, once data processing has started, the data processing must continue until processing is complete. If processing interruption is possible, interruptions have conventionally risked losing previously computed data, which requires restarting the data computations. In these cases, there has been no ability to start and stop data computation or to prioritize data to be computed when multiple computing requests are provided to the data center.

It is, therefore, an object of this disclosure to provide a flexible computing rack for interruptible computing in data centers. It is a further object of this disclosure to incorporate the use of artificial intelligence into a flexible computing rack for interruptible computing in data centers to provide processing flexibility, efficiently allocate computing resources, optimally employ available resources, monitor, and predict data computing workload patterns, start and stop data processing, and reduce electricity usage.

With the increasing demand for computational resources driven by AI applications, data centers face challenges in efficiently managing their computing power. Traditional server racks often lead to underutilization of available resources due to rigid configurations and lack of dynamic control mechanisms. There is a need for a flexible computing rack that can be easily controlled and reconfigured to support interruptible AI workloads to maximize the use of existing infrastructure while responding dynamically to power grid conditions, thermal constraints, and competing workload priorities through a unified multi-factor decision framework.

### SUMMARY

Systems and methods for allocating and managing computing resources are described. The system may use a flexible computing rack which includes a plurality of server devices, an artificial intelligence engine embedded at the rack level, and dual-grid power distribution units with per-slot individual power feeds to manage and allocate data computation in a data center. The system may execute computational allocation based on interruption factors which comprise a weighted combination of multiple parameters including prioritization of tasks, electrical power consumption, device temperatures, and scheduling constraints, and provide for state preservation and seamless resumption of interrupted workloads. The artificial intelligence engine may collect operational data representative of these characteristics of the data center, train machine learning models on rack-specific operational patterns, and provide efficiency enhancements and optimization for data computation through autonomous workload orchestration that responds to both internal rack conditions and external grid signals. The flexible computing rack integrates with dual power grids through redundant power paths including automatic transfer switches (ATS), uninterruptible power supplies (UPS), backup generators (BUG), power distribution units (PDU), and remote power panels (RPP), with individual power distribution to each server slot from both grids. A microgrid power distribution unit at the controller level enables grid-aware workload management and participation in demand response programs by adjusting interruption factors in response to external power availability signals.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a block diagram of a system for computing data using a flexible computing rack.

FIG. 2 illustrates a method of optimizing data processing tasks.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

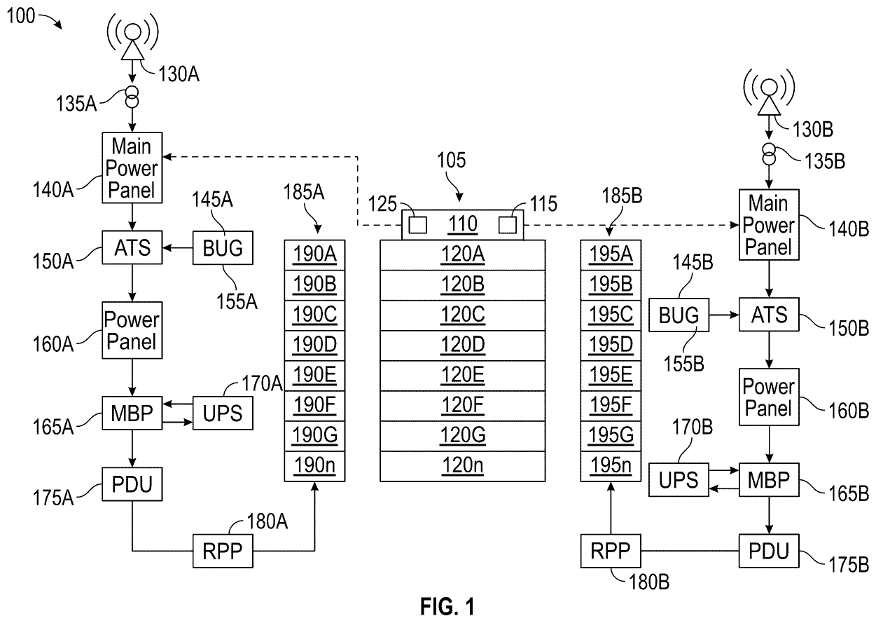

FIG. 1 illustrates a system 100 for computing data using a flexible computing rack 105. Flexible computing rack 105 includes a controller 110, which incorporates a microgrid power distribution unit 115 and a processor 125. Controller 110 may further include other devices which are necessary for computing information, such as non-volatile memory devices, connectors, power supplies, and data input connections accompanying processor 125. Controller 110 may be part of flexible computing rack 105 which may further include a plurality of slots 120A-120n which accept a server computer device. It is noted that the number of slots 120A-120n is merely exemplary. Flexible computing rack 105 may include any number of slots. Server computer devices within flexible computing rack 105 may include a combination of processors, microcontrollers, busses, volatile and non-volatile memory devices, non-transitory computer readable memory device and media, data processors, control devices, transmitters, receivers, antennas, transceivers, input devices, output devices, network interface devices, and other types of components that are apparent to those skilled in the art.

Controller 110 may detect, identify, and determine power and data needs for each one of the server devices disposed in slots 120A-120n, as will be discussed below. Processor 125 may further incorporate artificial intelligence and machine learning to forecast data and power needs, monitor data and power needs, notify users about potential data and power needs, and automatically control data and power needs. As a flexible computing rack, flexible computing rack 105 may further include a cooler device for maintaining a desired temperature for the server devices disposed in slots 120A-120n.

Each server device within the plurality of slots 120A-120n may have sole access to a power distribution unit from each of, for example, two independent power grids, though one or more may be implemented in practice. As shown in FIG. 1, a power distribution unit 190A-190n is assigned to server slot 120A-120n associated with power grid A 130A while a power distribution 195A-199n is also assigned to server slot 120A-120n associated with power grid B 130B depending on which power grid is providing power at a particular time. Power grid A 130A and Power Grid B 130B will be discussed in more detail below. Controller 110 may further receive information or instructions from a remote administrator computer (not shown) to facilitate operation of controller 110. Controller 110 may provide an optimal utilization of available computer server device processing power, as will be discussed below.

Processor 125 in controller 110 implements an artificial intelligence (AI) engine that operates at the rack level, distinguishing it from cluster-level or cloud-level orchestration systems. Processor 125 may include a combination of processors, microcontrollers, busses, volatile and non-volatile memory devices, non-transitory computer readable memory device and media, data processors, control devices, transmitters, receivers, antennas, transceivers, input devices, output devices, network interface devices, and other types of components that are apparent to those skilled in the art. Processor 125 may control the plurality of server devices in slots 120A-120n to direct a dynamic workload management, a state preservation mechanism, priority based workload scheduling, external power management, and seamless resumption protocols, which will be set forth below. Processor 125 may also be implemented as a server computer which uses artificial intelligence to recognize certain conditions within flexible computing rack 105 and change one or more parameters of workload processing (e.g., data processing) based on a unified multi-factor decision framework. In one embodiment, flexible computing rack 105 may implement general settings for managing workload allocation within flexible computing rack 105. Processor 125 may monitor the plurality of server devices disposed in slots 120A-120n to collect operational data. The operational data comprises at least power consumption data, temperature data, workload priority data, and scheduling data. In other words, processor 125 may collect data about how flexible computing rack 105 (which is for purposes of discussion here comprises server devices and computers in slots 120A-120n) allocates workload processing by flexible computing rack 105, how electricity is used, how much processing power per server unit in a flexible computing rack 105 is used at a particular time or for a particular work load. Once enough data is collected, processor 125 may train a machine learning model in the artificial intelligence engine to predict workload patterns of flexible computing rack 105 in real time. Processor 125 may further compare a predicted workload pattern over a certain amount of time to an actual workload pattern over the same amount of time to determine a relative accuracy of the prediction. In this manner, processor 125 may iteratively determine the accuracy of predictions and compare the predictions to optimization improvements identified by processor 125. In other words, the artificial intelligence engine implemented by processor 125, for example, may learn and predict a workflow and determine how to optimally allocate the workflow in flexible computing rack 105. At the same time, processor 125 may create an alternative processing plan based on optimized improvements. The alternative processing plan may be compared the actual processing efficiency to processing efficiency to determine the degree to which processor 125 may enhance processing allocations.

Once processor 125 has learned from collected data using artificial intelligence and machine learning techniques to a point where processor 125 has increased the efficiency of flexible computing rack 105, processor 125 may begin to provide automatic workload allocation instructions to controller 110 and servers via slots 120A-120n. For example, processor 125 may perform dynamic workload management which monitors data processing and predicts workload patterns in real time. Processor 125 identifies, for each of one or more data processing requests, an interruption factor comprising a weighted combination of at least two of: a power consumption parameter, a temperature parameter, a task priority parameter, and a scheduling parameter. Processor 125 computes a composite interruption factor for each workload by applying learned weighting coefficients to these parameters. Based on the interruption factors and the predicted workload patterns, processor 125 determines a processing order for the plurality of data processing requests. If a workload is paused, computational resources, such as server devices, in flexible computing rack 105 may be reallocated to other tasks or be instructed to go into an energy-saving mode, for example.

Processor 125 may further implement state preservation for data processing tasks. The plurality of servers in slots 120A-120n within flexible computing rack 105 may save data processing information within the servers in slots 120A-120n based on instructions from processor 125. State preservation allows flexible computing rack 105 to seamlessly change processing tasks without needing to restart a data processing process. State preservation may be particularly helpful in the context of artificial intelligence workloads, including both training and inference workloads, wherein the system captures sufficient computational state to resume execution after interruption without restarting the workload. For AI training workloads, the preserved state may include, for example, model parameters, optimizer state, and training iteration context, while for AI inference workloads, the preserved state may include, for example, request queue status, model cache information, and any relevant session context needed to continue serving requests consistently after resumption. Once processor 125 sends a command to interrupt a data processing task in flexible computing rack 105, the processing state of each one of the servers within flexible computing rack 105 may be stored within the plurality of servers in the plurality of slots 120A-120n. Flexible computing rack 105 server devices may proceed to process another set of data based on the interruption created by processor 125. At a point in the future, processor 125 may determine that the data processing task that was interrupted should be finished based on various parameters of flexible computing rack 105, which will be discussed below. Processor 125 may cause resumption of the interrupted data processing task in a suitable order among the servers in flexible computing rack 105 to resume an interrupted workload with performance consistency and without latency.

Processor 125 may receive further information from microgrid power distribution unit 115 to obtain information about electrical supply and use within flexible computing rack 105 and the servers in slots 120A-120n. Microgrid power distribution unit 115 manages power supplied to flexible computing rack 105 and controller 110, from dual power grids. For example, during period of high grid demand or energy shortages, processor 125 may identify a power consumption parameter as another interruption factor. In this manner, processor 125 may determine that the electrical power required to perform a particular data processing task exceeds the available electrical power supply and cause a data processing task to be paused. Processor 125 may determine that a high priority data processing task may continue but at a slower rate due to an electrical shortage causing a certain number of server devices within flexible computing rack 105 to be placed in a power saving mode. In this manner, processor 125 may pause low-priority processing tasks, reduce power consumption, and still perform high priority processing tasks. In one embodiment, processor 125 implements a demand response protocol in which interruption factors are adjusted based on external grid signals received via microgrid power distribution unit 115, so that during grid stress the system increases the importance of power consumption, pauses lower-priority workloads, places freed servers into low-power states, and continues high-priority workloads at a reduced processing rate. Processor 125 may also consider temperature as a component of the interruption factor. Temperature sensors associated with server devices in slots 120A-120n provide thermal data to processor 125. If a server device or a zone within flexible computing rack 105 approaches a thermal throttling threshold or a temperature that may reduce hardware lifespan, processor 125 may increase the temperature parameter weighting in interruption factor calculations. Processor 125 may further be provided with information about specific data request tasks from an administrator device. For example, an administrator device may authorize a high-priority data processing request, provide interruption settings to processor 125 for individual workloads for server devices in flexible computing rack 105. An administrator device may further provide threshold settings for pausing low-priority workloads based on interruption factors, such as energy use exceeding a rack power cap, device temperature exceeding a thermal management threshold, and workload priority falling below a preemption threshold. Processor 125 may use interruption factors to identify a processing plan and then automatically implement processing of one or more processing requests.

Processor 125 may receive further collect information from microgrid power distribution unit 115 to obtain information about electrical supply and use within flexible computing rack 105 and the servers in slots 120A-120n. Microgrid power distribution unit 115 manages power supplied to flexible computing rack 105 and controller 110. For example, during period of high grid demand or energy shortages, processor 125 may identify a power consumption parameter as another interruption factor. In this manner, processor 125 may determine that the electrical power required to perform a particular data processing task exceeds the available electrical power supply and cause a data processing task to be paused. Processor 125 may determine that a high priority data processing task may continue but at a slower rate due to an electrical shortage causing a certain number of server devices within flexible computing rack 105 to be placed in a power saving mode. In this manner, processor 125 may pause low-priority processing tasks, reduce power consumption, and still perform high priority processing tasks. Processor 125 may further be provided with information about specific data request tasks from an administrator device. For example, an administrator device may authorize a high-priority data processing request, provide interruption settings to processor 125 for individual workloads for server devices in flexible computing rack 105. An administrator device may further provide threshold settings for pausing low-priority workloads based on interruption factors, such as energy use, device temperature, and workload priority. Processor 125 may use interruption factors to identify a processing plan and then automatically implement processing of one or more processing requests.

Flexible computing rack 105 may further include a cooler which may be air or liquid based. The cooler may be implemented as a plurality of fans, heat sinks, coolant reservoirs, coolant tubing, or other cooling mechanism to provide cooling for flexible computing rack 105. The cooler may be tailored to specific requirements of the various devices within flexible computing rack 105.

Flexible computing rack 105 may monitor system performance, allocate resources dynamically based on interruption factors, interrupt processing workloads with state preservation, and resume processing workloads from the paused state. Flexible computing rack 105 is further a modular design which allows various elements to be removed for maintenance or added without disrupting processing capability. Flexible computing rack 105 provides for flexible solutions in data centers to improve computing resource utilization, employs artificial intelligence, and easily integrates into existing infrastructure of a data center.

As shown in FIG. 1, power may be supplied to flexible computing rack 105 in a variety of ways from different power grids, such as grid A 130A and grid B 130B. It is conceivable that one power grid may be used, or a plurality of power grids may supply power to flexible computing rack 105. Typically, grid A 130A and grid B 130B are public utilities. However, other power sources could be implemented, such as solar or wind turbine, or battery storage systems integrated into a microgrid architecture could also be used.

Power transmitted from grid A 130A may be regulated by a transformer 135A, which adjusts a voltage and amperage of supplied power to a main power panel 140A. Standard power supply from transformer 135A is typically 480V three-phase or 220V, which is then distributed through the main power panel to appropriate voltage levels. However, any transformer 135A can be used to create any desirable voltage and amperage supply to main power panel 140A. Main power panel 140A may provide a series of electrical circuit breakers which feed power to individual flexible computing racks 105 (if more than one is implemented in a particular data center). Main power panel 140A may supply power directly to controller 110.

Main power panel 140A may further be coupled, after the electronic circuit breakers, to an automatic transfer switch (“ATS”) 150A which operates as a failsafe to ensure that power is always available to flexible computing racks 105 and the servers in slots 120A-120n by power distribution unit 185A. If a power loss is detected by automatic transfer switch 150A, an automatic switch 145A may be triggered in back-up generator (“BUG”) 155A to cause back-up generator 155A to create electricity to serve flexible computing rack 105. A power panel 160A may be used, along with a maintenance bypass panel (“MBP”) 165A, to ensure that power is able to flow during maintenance of power panel 160A. As a back-up an uninterruptible power supply (“UPS”) 170A may implement a power storage device, such as a battery, which may supply electricity on a temporary basis during maintenance of the power system.

Electricity supplied by grid A 130A, back-up generator 155A, or uninterruptible power supply 170A may be conducted to a power distribution unit (“PDU”)175A for providing power to flexible computing rack 105. Power distribution unit 175A may further employ a remote power panel (“RPP)” 180A to provide power to rack power distribution unit 185A and each individual power distribution unit 190A-190n for each individual server slot 120A-120n in flexible computing rack 105.

Grid B 130B may operate in a fashion similar to that discussed above with respect to grid A 130A. Power transmitted from grid B 130B may be regulated by a transformer 135B, which adjusts a voltage and amperage of supplied power to a main power panel 140B. Standard power supply from transformer 135B is typically 480V three-phase or 220V, which is then distributed through the main power panel to appropriate voltage levels. However, any transformer 135B can be used to create any desirable voltage and amperage supply to main power panel 140B. Main power panel 140B may provide a series of electrical circuit breakers which feed power to individual flexible computing racks 105 (if more than one is implemented in a particular data center). Main power panel 140B may supply power directly to controller 110.

Main power panel may further be coupled, after the electronic circuit breakers, to an automatic transfer switch (“ATS”) 150B which operates as a failsafe to ensure that power is always available to flexible computing racks 105 and the servers in slots 120A-120n by power distribution unit 185B. If a power loss is detected by automatic transfer switch 150B, an automatic switch 145B may be triggered in back-up generator (“BUG”) 155B to cause back-up generator 155B to create electricity to serve flexible computing rack 105. A power panel 160B may be used, along with a maintenance bypass panel (“MBP”) 165B, to ensure that power is able to flow during maintenance of power panel 160B. As a back-up an uninterruptible power supply (“UPS”) 170B may implement a power storage device, such as a battery, which may supply electricity on a temporary basis during maintenance of the power system.

Electricity supplied by grid B 130B, back-up generator 154B, or uninterruptible power supply 170B may be conducted to a power distribution unit (“PDU”)175B for providing power to flexible computing rack 105. Power distribution unit 175B may further employ a remote power panel (“RPP)” 180B to provide power to rack power distribution unit 185B and each individual power distribution unit 195A-195n for each individual server slot 120A-120n in flexible computing rack 105. Flexible computing rack 105 may be integrated into data centers, allowing for dynamic allocation and management of computing resources. Flexible computing rack 105 is capable of supporting various types of servers and AI workloads, enabling efficient use of underutilized computing power. Key features include:

Dynamic Workload Management: The system employs resource allocation algorithms that monitor and predict workload patterns in real-time. When a workload is paused, computational resources are reallocated to other tasks or placed in an energy-saving mode, ensuring optimal utilization of available resources.

State Preservation Mechanism: Each server slot within the rack is equipped with state preservation capabilities, allowing AI workloads to save their progress before interruption. This ensures that computations can resume seamlessly from the exact point of suspension, avoiding the need to restart processes such as model training.

Priority-Based Scheduling: The control system integrates priority-based scheduling protocols to determine which workloads can be interrupted based on urgency and resource availability. High-priority tasks remain uninterrupted, while lower-priority tasks are dynamically paused when necessary.

Grid-Aware Integration: The rack is designed to interact with external power management systems or microgrids, enabling it to adapt its operations during periods of high grid demand or energy shortages. By pausing non-critical workloads, the system reduces power consumption without compromising essential functions. For example, the afternoon is typically a period of high energy use, particularly in the summer. Flexible computing rack 105 may temporarily pause data processing requests to reduce electrical draw on a power grid during periods of high use, such as afternoons in the summer.

Remote Control Interface: A centralized software interface allows operators to configure interruptibility settings for individual workloads or server slots remotely. This includes setting thresholds for pausing based on energy use, temperature, or workload priority.

Seamless Resumption Protocols: Upon resumption after interruption, the system verifies resource availability and reactivates paused workloads in an orderly manner, ensuring performance consistency and avoiding latency issues.

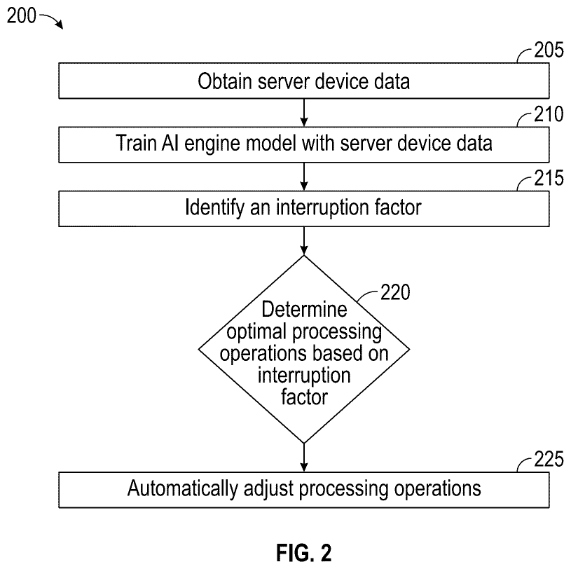

FIG. 2 illustrates a method 200 of optimizing data processing tasks within system 100, shown and described above with respect to FIG. 1. Method 200 begins at step 205 where a processor 125 (shown in FIG. 1) may obtain server device data about one or more server devices, such as server devices and computers within flexible computing rack 105. Server data may be monitored by processor 125 in real-time. The obtained server device data comprises operational data including at least power consumption data, temperature data, workload priority data, and scheduling data. Processor 125 may use the server device data to train an artificial intelligence model at step 210. Processor 125 may predict future workload patterns based on the obtained server device data and the artificial intelligence model. Processor 125 may further identify an interruption factor, which may be, for example, a timing, schedule, priority, temperature, energy use or workflow parameter which will affect a requested workflow pattern. Based on the interruption factor, processor 125 may, at step 220, determine optimal processing operations based on the identified interruption factor. For example, processor 125 may determine a workflow processing order for data processing requests based on interruption factors associated with the various data processing requests. In one more detailed example, an energy use parameter or temperature parameter may cause processor 125 to interrupt a low-priority workflow request in favor of a high priority workflow request. Various iterations of these interruption factors are contemplated herein, with the overriding teaching being that processor 125 optimizes workflow processing to perform the workflow processing requests with the highest priority indications, as quickly as possible based on available computing resources. Data processing requests may be parsed to spread the data processing request among a plurality of server computers, paused based on a pre-set time, may be temporarily terminated or reassigned based on temperature or energy use conditions, may be temporarily terminated or reassigned based on schedule or workflow priority, while respecting power, thermal, and scheduling constraints.

At step 225, processor 125 may automatically adjust processing operations 225 in accordance with the interruption factors to implement a workflow processing order that maximizes the processing capacity for the highest priority workflow tasks. Processor 125 may further obtain data from these automatic adjustments in step 225 to refine the training model in step 210 for future improvements in workflow processing optimization. This closed-loop feedback enables continuous learning and adaptation by the artificial intelligence engine to specific operational characteristics of flexible computing rack 105.

The flexible computing rack comprises a chassis that houses multiple server slots, each capable of accommodating various types of servers optimized for AI workloads. Each slot is equipped with power distribution units (PDUs) and cooling solutions tailored to the specific requirements of the installed hardware.

The control system is implemented through a software interface that allows operators to monitor system performance, allocate resources dynamically, and interrupt workloads. This interface can be accessed remotely, providing flexibility in managing data center operations from any location.

The modular design allows for easy upgrades and maintenance, enabling operators to replace or add components without disrupting overall operations.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a flexible computing rack, the flexible computing rack including an artificial intelligence engine device which:
monitors workload patterns in real-time;
identifies an interruption factor for each of one or more data processing requests;
determines a processing order for the one or more data processing requests; and
automatically adjusts the processing order based on the interruption factor for each of the one or more data processing requests.

2. The system of claim 1, wherein the interruption factor is a timing based interruption factor, where the one or more data processing requests are interrupted based on a pre-set interruption at a particular specified time.

3. The system of claim 1, wherein the interruption factor is one of a schedule based interruption factor and a priority based interruption factor.

4. The system of claim 1, wherein the interruption factor is one of a temperature based interruption factor and an energy use based interruption factor.

5. The system of claim 1, wherein the interruption factor is a workflow parameter based interruption factor which is a predetermined user specified interruption factor.

6. The system of claim 1, wherein the flexible computing rack includes a controller which controls one or more server computers.

7. The system of claim 6, wherein the flexible computing rack controller directs one or more server computers to temporarily pause processing of the one or more data processing requests.

8. The system of claim 7, wherein the flexible computing rack controller directs one or more server computers to temporarily pause processing of the one or more data processing requests based on an energy use condition.

9. The system of claim 1, wherein the artificial intelligence engine is trained based on monitored workload pattern data from one or more server computers to predict a future workload pattern for the one or more server computers.

10. A method, comprising:
monitoring, by a server device, workload patterns in real-time;
identifying, by the server device, an interruption factor for each one of one or more data processing requests;
determine, by the server device, a processing order for the one or more data processing requests;
automatically adjusting, by the server device, the processing order based on the interruption factor for each of the one or more data processing requests.

11. The method of claim 10, wherein the interruption factor is a timing based interruption factor, where the one or more data processing requests are interrupted based on a pre-set interruption at a particular specified time.

12. The method of claim 10, wherein the interruption factor is one of a schedule based interruption factor and a priority based interruption factor.

13. The method of claim 10, wherein the interruption factor is one of a temperature based interruption factor and an energy use based interruption factor.

14. The method of claim 10, wherein the interruption factor is a workflow parameter based interruption factor which is a predetermined user specified interruption factor.

15. The method of claim 10, wherein the interruption factor is a timing based interruption factor and further comprising interrupting the one or more data processing requests based on a pre-set interruption at a particular specified time.

16. The method of claim 15, further comprising directing one or more server computers to temporarily pause processing of the one or more data processing requests.

17. The method of claim 16, further comprising directing one or more server computers to temporarily pause processing of the one or more data processing requests based on an energy use condition.

18. The system of claim 1, further comprising training, by the artificial intelligence engine, with on prior data from one or more server computers and, predicting a future workload pattern for the one or more server computers based on the training.

19. A flexible computing rack, comprising:
a chassis with multiple server slots;
a controller; and
an artificial intelligence engine;
wherein the flexible computing rack:
monitors workload patterns in real-time;
identifies an interruption factor for each of one or more data processing requests;
determines a processing order for the one or more data processing requests; and
automatically adjusts the processing order based on the interruption factor for each of the one or more data processing requests.

20. The flexible computing rack of claim 19, further comprising a cooler to cool the temperature of the flexible computing rack.
